(19) United States
(12) Patent Application Publication
(10) Pub. No.: US 2013/0329003 A1
(43) Pub. Date: Dec. 12, 2013

(54) VIDEO CAMERA POSITIONING SYSTEM AND CONTROL METHOD THEREOF

(71) Applicants: Ming-Hung HSIA, New Taipei City (TW); Ying-Feng HSU, New Taipei City (TW); Hui-Lun HUNG, New Taipei City (TW); Yo-Jung WANG, New Taipei City (TW)

(72) Inventors: Ming-Hung HSIA, New Taipei City (TW); Ying-Feng HSU, New Taipei City (TW); Hui-Lun HUNG, New Taipei City (TW); Yo-Jung WANG, New Taipei City (TW)

(73) Assignee: AVer Information Inc., New Taipei City (TW)

(21) Appl. No.: 13/490,427

(22) Filed: Jun. 6, 2012

(51) Int. Cl. H04N 5/262; H04N 7/00

(52) U.S. Cl. 348/36; 348/E05.024; 348/E05.051

(57) ABSTRACT

A method for controlling a video camera positioning system includes the steps of controlling a motor for driving a video camera to capture a panoramic frame, dividing the panoramic frame into a plurality of frames, controlling the motor for driving the camera lens to turn to the frame corresponding to an encoded command signal when the microcontroller receiving the encoded command signal, and zooming in the frame by the video camera. Furthermore, a video camera positioning system is also disclosed herein.

### BACKGROUND

1. Technical Field Disclosure

The embodiment of the present disclosure relates generally to photography and, more particularly, to a video camera positioning system and a method for controlling thereof.

2. Description of Related Art

Positioning a video camera is required in using an IP camera, a web cam or a videoconference system. When a user needs to locate an area inside (or outside) a frame or zoom in an area, a remote control is required to drive the video camera to slowly turn to the area which is needed to be zoomed in. The above-mentioned operation is time-wasting and complicated.

Many efforts have been devoted trying to find a solution of the aforementioned problems. Nonetheless, there still a need to improve the existing apparatus and techniques in the art. Therefore, it is an important subject and also a purpose in need of improvement that how to solve the problem of a conventional positioning mode being time-wasting and complicated.

### SUMMARY

A video camera positioning system and a method for controlling thereof are provided, which addresses the problem of a conventional positioning mode being time-wasting and complicated.

One aspect of the embodiment of the present disclosure is to provide a method for controlling a video camera positioning system, and the video camera positioning system comprises a video camera, a motor, and a micro controller. The method comprises: controlling the motor for driving the video camera to capture a panoramic frame; dividing the panoramic frame into a plurality of frames, wherein each of the frames comprises encoded information; controlling the motor turning the video camera lens to the frame corresponding to an encoded command signal when the micro controller receiving the encoded command signal; and zooming in the frame.

In one embodiment of the present disclosure, the panoramic frame is divided into n×n frames by the micro controller, and n is a positive integer and greater than 2. The micro controller controls the motor to turn the camera lens to the frame for a distance. The motor is controlled by the micro controller to rotate with first speed when the distance is greater than 2n−3 frames; the motor is controlled by the micro controller to rotate with second speed when the distance is one frame; and the motor is controlled by the micro controller to rotate with third speed when the distance is less than 2n−3 frames and greater than one frame.

In another embodiment of the present disclosure, the micro controller is operable to look up a distance-speed table for obtaining the first speed, the second speed, and the third speed respectively when the distance is greater than 2n−3 frames, one frame, and less than 2n−3 frames and greater than one frame.

In yet another embodiment of the present disclosure, the frame is divided into a plurality of subframes by the micro controller, and each of the subframes comprises the encoded information. The micro controller is operable to control the motor to turn the camera lens to the subframe corresponding to the encoded command signal when the micro controller receives the encoded command signal such that the video camera further zooms in the subframe.

In still another embodiment of the present disclosure, if the micro controller receives a zoom out command signal at the time the video camera zooms in any frame of the panoramic frame, the video camera is controlled by the micro controller to zoom out the frame captured by the video camera and return to the panoramic frame. If the video camera zooms in any subframe of the frame at the time the micro controller receives a zoom out command signal, the video camera is controlled by the micro controller to zoom out the subframe captured by the video camera and return to the frame.

In another aspect of the embodiment of the present disclosure, a video camera positioning system is provided. The video camera positioning system comprises a video camera, a motor, and a micro controller. The motor is electrically connected to the video camera. The micro controller is electrically connected to the motor and operable to control the motor to drive the video camera to capture a panoramic frame. The micro controller is operable to divide the panoramic frame into a plurality of frames, and each of the frames comprises encoded information. The micro controller is operable to control the motor to turn a camera lens to the frame corresponding to an encoded command signal when the micro controller receives the encoded command signal, such that the video camera zooms in the frame.

In one embodiment of the present disclosure, in operation, the micro controller is operable to divide the panoramic frame into n×n frames, and n is a positive integer greater than 2. The micro controller is operable to control the motor to turn the camera lens to the frame for a distance. The micro controller is operable to control the motor to rotate with a first speed when the distance is greater than 2n−3 frames, the micro controller is operable to control the motor to rotate with a second speed when the distance is one frame, and the micro controller is operable to control the motor to rotate with a third speed when the distance is less than 2n−3 frames and greater than one frame.

In another embodiment of the present disclosure, the video camera positioning system further comprises a memory. The memory is operable to store a distance-speed table, and the micro controller is operable to look up the distance-speed table for obtaining the first speed, the second speed, and the third speed respectively when the distance is greater than 2n−3 frames, equal to one frame, and less than 2n−3 frames and greater than one frame.

In yet another embodiment of the present disclosure, in operation, the micro controller is operable to divide the frame into a plurality of subframes, and each of the subframes comprises the encoded information. The micro controller is operable to control the motor turn the camera lens to turn to the subframe corresponding to the encoded command signal when the micro controller receives the encoded command signal, such that the video camera further zooms in the subframe.

In still another embodiment of the present disclosure, if the micro controller receives a zoom-out command signal at the time the video camera zooms in any frame of the panoramic frame, the micro controller is operable to control the video camera to reduce the frame captured by the video camera and return to the panoramic frame. If the micro controller receives the zoom out command signal at the time the camera zooms in any subframe of the frame, the micro controller is operable to control the video camera to zoom out the subframe captured by the video camera and return to the frame.

As a result, the embodiments of the present disclosure provide a video camera positioning system and a method for controlling thereof. By recording the panoramic frame in advance, so as to avoid the problem of unable to select an edge portion of a frame for zoom in, regardless the object of interest being too large or the visual angle of the camera being too small. Also, it can be zoomed in for single frame or subframe or a region frame consisted of a plurality of frames or subframes. The zoomed in frame can be further divided for the user to perform multiple zoom-in processes based on the actual requirement.

Moreover, the embodiment of the present disclosure provides a video camera positioning system and a method for controlling thereof so as to adjust the motor rotation speed depending on the distance to let the motor rotate with a optimized speed when the distance is farther, such that the positioning time is reduced. In other words, the positioning time is just the same for a user each time even if the distance is farther because the positioning time is adjusted as the above-mentioned way. Moreover, the micro controller can control the outputting current of the motor based on the distance such that the motor is capable of rotating in different speeds based on various scenario so as to reduce power consumption.

### BRIEF DESCRIPTION OF THE DRAWINGS

The disclosure can be more fully understood by reading the following detailed description of the embodiments, with reference made to the accompanying drawings as follows:

FIG. 1 schematically shows a circuit block diagram of a video camera positioning system according to embodiments of the present disclosure.

FIG. 2 schematically shows a diagram of a trajectory of a video camera during recording according to embodiments of the present disclosure.

FIG. 3 schematically shows a diagram of dividing portions of a panoramic frame according to embodiments of the present disclosure.

FIG. 4 schematically shows a diagram of dividing portions of a panoramic frame according to embodiments of the present disclosure.

FIG. 5a schematically shows a diagram of dividing portions of a panoramic frame according to embodiments of the present disclosure; FIG. 5b schematically shows a diagram of an zoomed-in frame of the panoramic frame of FIG. 5a according to embodiments of the present disclosure; FIG. 5c schematically shows a diagram of an zoomed-in frame of the panoramic frame of FIG. 5a according to embodiments of the present disclosure; FIG. 5d schematically shows a diagram of an zoomed-in frame of the panoramic frame of FIG. 5a according to embodiments of the present disclosure.

FIG. 6 schematically shows a diagram of a panoramic frame according to embodiments of the present disclosure.

FIG. 7 schematically shows a diagram of a trajectory of a camera lens during capturing frames according to embodiments of the present disclosure.

FIG. 8 schematically shows a flow diagram of a method for controlling a video camera positioning system according to embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

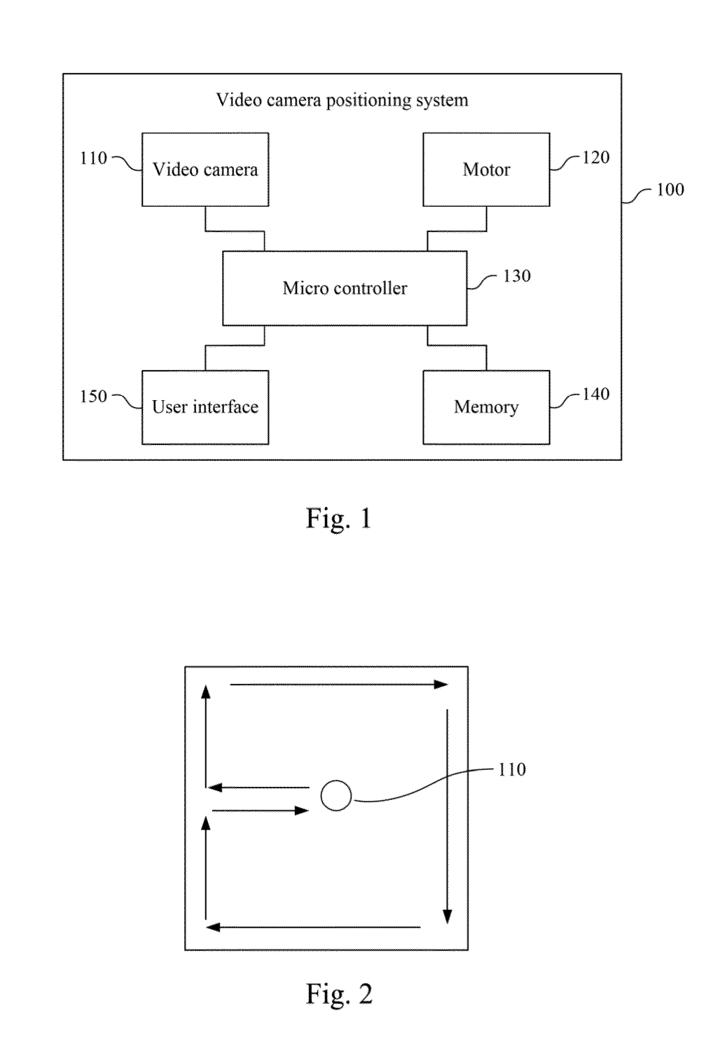

FIG. 1 schematically shows a circuit block diagram of a video camera positioning system 100 according to embodiments of the present disclosure. The video camera positioning system 100 comprises a video camera 110, a motor 120, a micro controller 130, a memory 140, and a user interface 150. In configuration, the video camera 110, the motor 120, the memory 140, and the user interface 150 are electrically connected to the micro controller 130. Furthermore, the motor 120 is electrically connected to the video camera 110.

In operation, the micro controller 130 is operable to control the motor 120 to drive the video camera 110 to capture a panoramic frame. The micro controller 130 is operable to divide the panoramic frame into a plurality of frames, and each of the frames comprises encoded information. The micro controller 130 is operable to control the motor 120 to drive the camera lens to turn to the frame corresponding to an encoded command signal when the micro controller 130 receives the encoded command signal such that the video camera 110 zooms in the frame.

For example, as shown in FIG. 2, which schematically shows a diagram of a trajectory of a video camera 110 during recording according to embodiments of the present disclosure. First of all, the video camera 110 is positioned in the center, and the micro controller 130 then controls the motor 120 such that the video camera 110 is drove to turn in clockwise direction according to the trajectory as shown in FIG. 2 for capturing frame, that is to say, the video camera positioning system 100 performs a panoramic scanning process. The frames captured by the video camera 110 are combined to form a panoramic frame.

Hence, the video camera positioning system 100 of the embodiment of the present disclosure records the panoramic frame in advance, so as to avoid the problem of unable to select an edge portion of a frame for zoom in, regardless the object of interest being too large or the visual angle of the video camera 110 being too small.

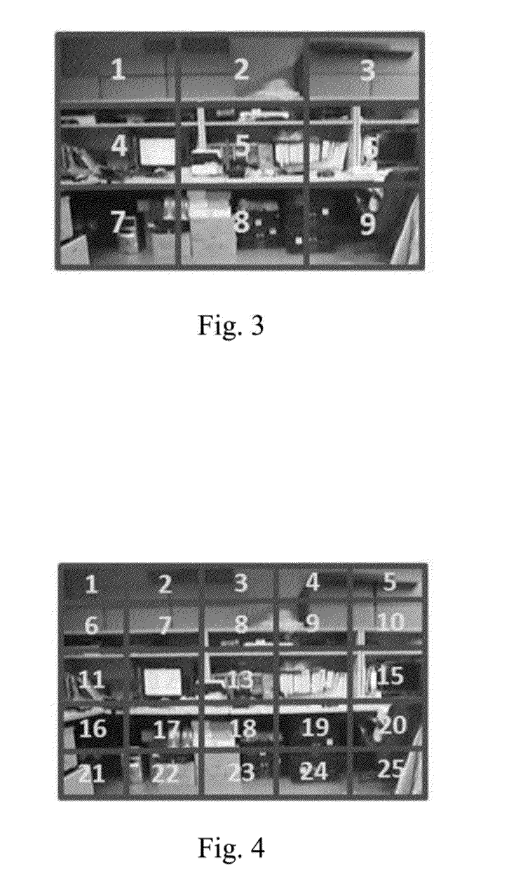

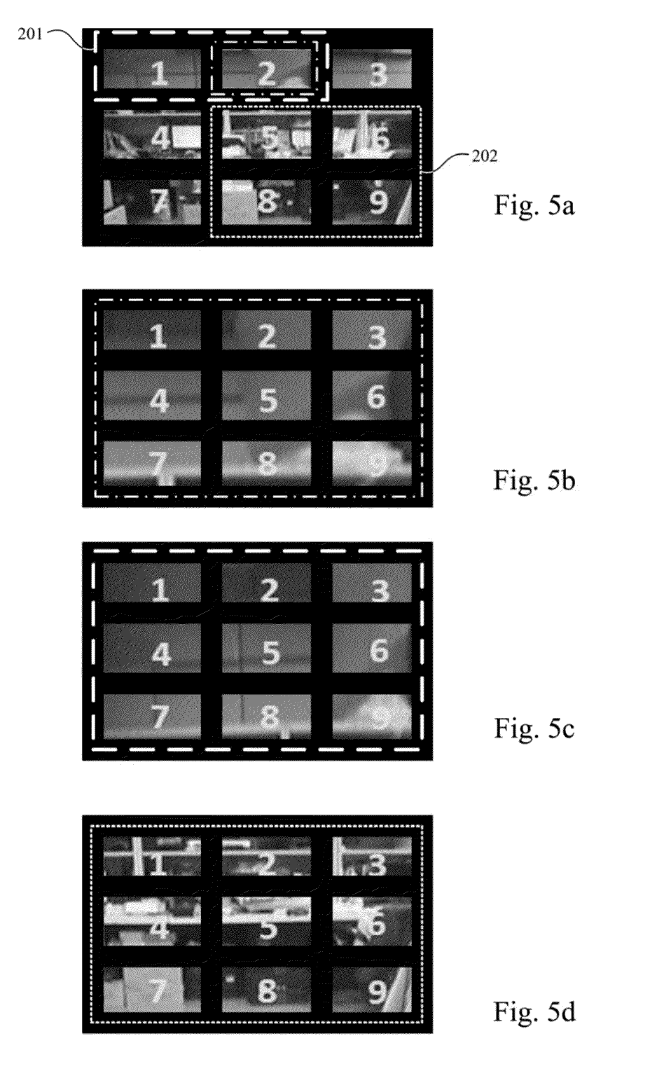

Furthermore, as shown in FIGS. 3 and 4, which schematically show a diagram of dividing portions of a panoramic frame according to embodiments of the present disclosure, and FIG. 5a schematically shows a diagram of dividing portions of a panoramic frame according to embodiments of the present disclosure. The micro controller 130 can divide the panoramic frame into 9 frames as shown in FIG. 3 or 25 frames as shown in FIG. 4, and each of the frames comprises encoded information. The divided type of FIG. 3 is used as an example, the code of the frame on the upper-left corner is 1, the code of the frame on the mid-upper is 2, and so on. However, the present disclosure is not limited in this regard, and those skilled in the art can divide the panoramic frame into a plurality of frames with different numbers and size, depending on actual requirements.

In one embodiment, the panoramic frame captured by the video camera 110 of FIG. 5a is used as an example. A user can enter a command manually through the user interface 150. For example, the user interface 150 can be a keyboard, a remote control, and so forth. When a user presses a key labeled by 2, the user interface 150 generates an encoded command signal. The encoded command signal is corresponding to the code 2. When the micro controller 130 receives the encoded command signal, the micro controller 130 controls the motor 120 to drive the camera lens to turn to the frame corresponding to the encoded command signal, and said frame is labeled by 2 such that the video camera 110 zooms in the frame labeled by 2. The zoomed-in frame is shown in FIG. 5b.

Hence, the video camera positioning system 100 of the embodiment of the present disclosure can divide the panoramic frame into a plurality of frames such that a user can select the frame he wants to zoom in through the user interface 150, and therefore, there is no need an additional instrument.

In another embodiment, the encoded command signal is generated by at least one number. When the micro controller 130 receives the encoded command signal, the motor 120 is controlled to drive the camera lens to turn to at least one frame corresponding to the encoded command signal such that the video camera 110 can zoom in at least one frame.

The operation mode of generating the encoded command signal by one number is as mentioned above, and operation mode of generating the encoded command signal by more than two numbers is described as follows.

Referring to FIG. 5a, a user can enter a command manually through the user interface 150. When the user presses keys labeled by 1 and 2 in turn, the user interface 150 generates an encoded command signal. The encoded command signal is corresponding to the code 1 and 2. When the micro controller 130 receives the encoded command signal, the micro controller 130 controls the motor 120 to drive the camera lens to turn to a region frame 201 consisted of two frames labeled by 1 and 2 such that the video camera 110 zooms in the region frame. The zoomed-in region frame is shown in FIG. 5c.

In addition, in another embodiment, referring to FIG. 5a, when the user presses keys labeled by 5 and 9 in turn, the user interface 150 generates an encoded command signal. The encoded command signal is corresponding to the code 5 and 9. When the micro controller 130 receives the encoded command signal, the micro controller 130 controls the motor 120 to drive the camera lens to turn to a region frame 202 consisted of four frames covered by two oblique angle frames labeled by 5 and 9, for example, the region frame 202 is consisted of the frames labeled by 5, 6, 8 and 9, such that the video camera 110 zooms in the region frame. The zoomed-in region frame is shown in FIG. 5d. In this embodiment, the user can enter commands corresponding to 6 and 8 through the user interface 150, at this time, the region frame 202 is consisted of four frames covered by two oblique angle frames labeled by 6 and 8, and the region frame 202 generated by entering commands corresponding to 6 and 8 is the same as the region frame 202 generated by entering commands corresponding to 5 and 9 through the user interface 150. In addition, the region frame 202 can be obtained by entering commands corresponding to 9 and 5 in turn or entering commands corresponding to 8 and 6 in turn.

Similarly, when a user enters commands corresponding to 1 and 5, or 2 and 4 through the user interface 150, the video camera 110 will zoom in the region frame consisted of 1, 2, 4, and 5 through the above-mentioned operation. In summary, when a user enters commands corresponding to two oblique angle numbers through the user interface 150, the region frame obtained by entering the commands is a square region traversed by the above-mentioned numbers.

In another embodiment, the micro controller 130 can further divide the frame into a plurality of subframes, and each of the subframes comprises encoded information. The micro controller 130 is operable to control the motor 120 to drive the camera lens to turn to the subframe corresponding to an encoded command signal when the micro controller 130 receives the encoded command signal such that the video camera 110 further zooms in the subframe.

For example, as shown in FIG. 5a, when the user presses a key labeled by 2 through the user interface 150, the video camera 110 will zoom in the frame labeled by 2 through the above-mentioned operation. The micro controller 130 can further divide the frame into a plurality of subframes, for example, the micro controller 130 can divide the frame into 9 subframes as shown in FIG. 5b. These subframes comprise encoded information as shown in the Figure respectively, at this time, the user can enter a number through the user interface 150 again, and the video camera 110 can further zoom in the corresponding subframe through the above-mentioned operation. Furthermore, the operation mode the user enters two of more numbers through the user interface 150 is the same as the operation mode the user enters one number, and accordingly, a detail description of the operation mode the user enters two of more numbers is omitted herein for the sake of brevity.

Hence, a user can use the video camera positioning system 100 of the embodiment of the present disclosure to zoom in single frame or subframe based on actual requirement or zoom in a region frame consisted of a plurality of frames or subframes. The zoomed-in frame can be to further perform zoom-in processes based on the user's requirement.

In an optional embodiment, a user can enter a zoom out command manually through the user interface 150, and the user interface 150 will generate a zoom out command signal. If the video camera 110 zooms in any frame of the panoramic frame at the time the micro controller 130 receives the zoom-out command signal, the micro controller 130 is operable to control the video camera 110 to reduce the frame captured by the video camera 110 and return to the panoramic frame. Furthermore, if the video camera 110 zooms in any subframe of the frame at the time the micro controller 130 receives the zoom out command signal, the micro controller 130 is operable to control the video camera 110 to reduce the subframe captured by the video camera 110 and return to the frame.

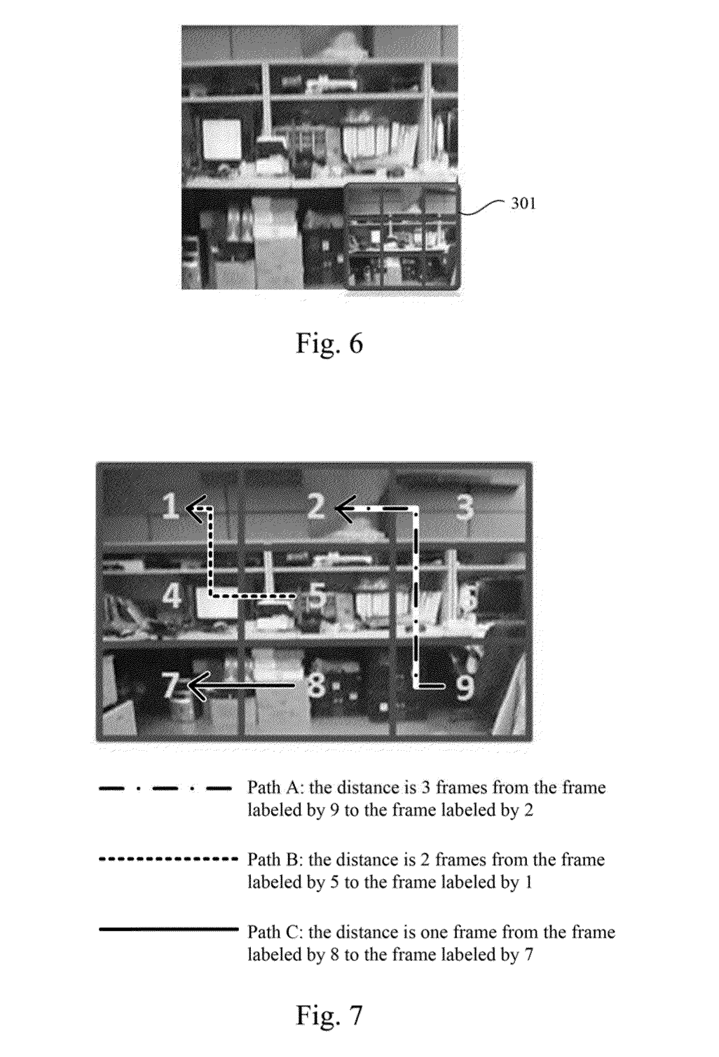

FIG. 6 schematically shows a diagram of a panoramic frame according to embodiments of the present disclosure. As shown in the figure, the reduced panoramic frame 301 can be disposed in the lower-right corner of the panoramic frame for a user to perform a speedy positioning process and a zoom-in process. However, the scope of the present disclosure is not limited in this regard, and those skilled in the art can selectively dispose the reduced panoramic frame in a proper position of the panoramic frame depending on actual requirements.

FIG. 7 schematically shows a diagram of a trajectory of a camera lens during capturing frames according to embodiments of the present disclosure. In operation, the micro controller 130 is operable to divide the panoramic frame into n×n frames, and n is a positive integer and greater than 2. The micro controller 130 controls the motor 120 to drive the camera lens to turn to the frame for a distance. The micro controller 130 is operable to control the motor 120 to rotate with first speed when the distance is greater than 2n−3 frames, the micro controller 130 is operable to control the motor 120 to rotate with second speed when the distance is one frame, and the micro controller 130 is operable to control the motor 120 to rotate with third speed when the distance is less than 2n−3 frames and greater than one frame.

For example, as shown in FIG. 7, the micro controller 130 can divide the panoramic frame into 3×3 frames and control the motor 120 to drive the camera lens to turn to the frame for a distance.

Reference is now made to path A, when the camera lens is turned from the frame labeled by 9 to the frame labeled by 2, said distance is 3 frames. At this time, the micro controller 130 controls the motor 110 to rotate with first speed (for example: high speed). Referring to path C, when the camera lens is turned from the frame labeled by 8 to the frame labeled by 7, said distance is one frame. At this time, the micro controller 130 controls the motor 110 to rotate with third speed (for example: low speed). Referring to path B, when the camera lens is turned from the frame labeled by 5 to the frame labeled by 1, said distance is 2 frames. At this time, the micro controller 130 controls the motor 120 to rotate with second speed (for example: a speed between the high speed and the low speed).

As mentioned above, when the camera lens needs to be moved for more than 3 frames, at this time, the micro controller 130 controls the motor 110 to rotate with high speed for speedy positioning due to the moved distance of the camera lens being farther. When the camera lens needs to be moved for merely one frame, at this time, the micro controller 130 controls the motor 110 to rotate with low speed due to the moved distance of the camera lens being nearer. When the camera lens needs to be moved for 2 frames, at this time, the micro controller 130 controls the motor 110 to rotate with a speed between said high speed and said low speed due to the moved distance of the camera lens being normal.

Hence, the way to adjust the motor rotation speed depending on the distance can let the motor 120 rotate with a proper speed when the distance is farther such that the positioning time can be reduced, that is to say, the positioning time is just the same for a user each time even if the distance is farther because of the positioning time is adjusted as the above-mentioned way. Moreover, the micro controller 130 can control the outputting current of the motor 120 based on the distance such that the motor 120 can rotate in different speeds properly in order to reduce power consumption.

In still another embodiment, the memory 140 of the video camera positioning system 100 is operable to store a distance-speed table, and the micro controller is operable to look up the distance-speed table for obtaining the first speed, the second speed, and the third speed respectively when the distance is greater than 2n−3 frames, is one frame, and is less than 2n−3 frames and greater than one frame. However, the present disclosure is not intended to be limited to this regard, the rotation speed of the motor 120 can be obtained by looking up the distance-speed table or calculated by the micro controller 130 directly according to the distance.

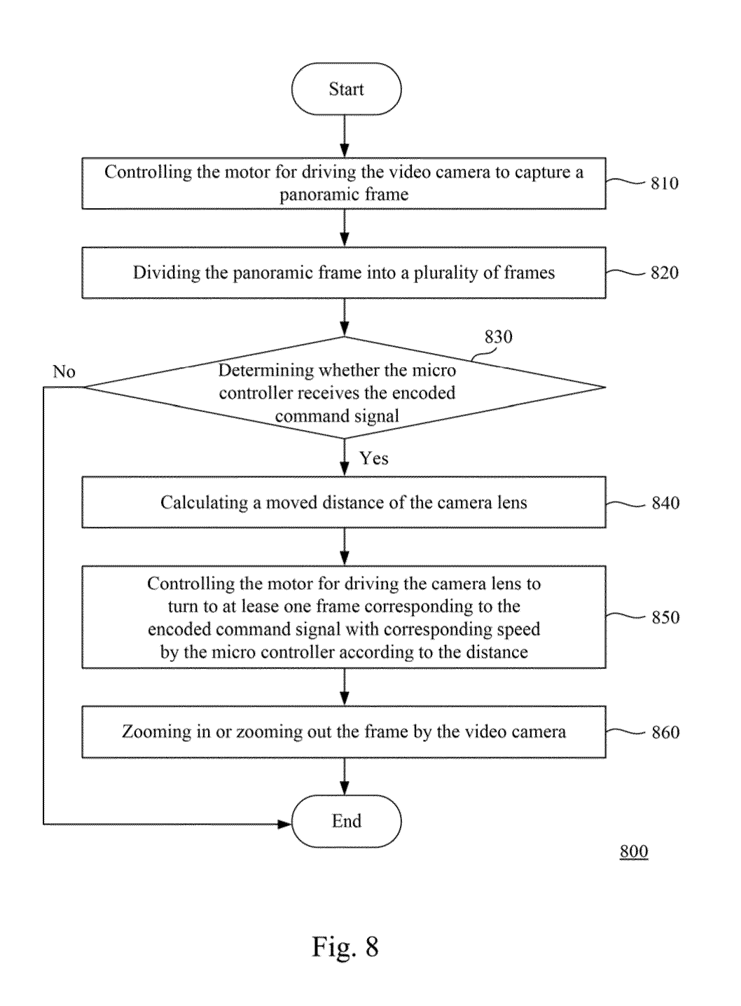

FIG. 8 schematically shows a flow diagram of a method 800 for controlling a video camera positioning system according to embodiments of the present disclosure. As shown in the figure, the method for controlling a video camera positioning system 800 comprises the steps of: controlling the motor for driving the video camera to capture a panoramic frame (step 810); dividing the panoramic frame into a plurality of frames, wherein each of the frames comprises encoded information (step 820); determining whether the micro controller receives the encoded command signal (step 830); calculating a moved distance of the camera lens (step 840); controlling the motor for driving the camera lens to turn to at lease one frame corresponding to the encoded command signal with corresponding speed by the micro controller according to the distance (step 850); zooming in or zooming out the frame by the video camera (step 860).

Reference is now made to both FIGS. 1 and 8. In step 810, the micro controller 130 can be used to control the motor 120 such that the video camera 110 can capture a panoramic frame. The trajectory for capturing the panoramic frame is shown in FIG. 2, and accordingly, a detail description regarding to the above-mentioned way is omitted herein for the sake of brevity.

Hence, the method 800 for controlling the video camera positioning system of the embodiment of the present disclosure records the panoramic frame in advance, so as to avoid the problem of unable to select the edge portion for zoom in, regardless the object of interest being too large or the visual angle of the video camera 110 being too small.

In step 820, the panoramic frame can be divided into a plurality of frames by the micro controller 130 as shown in FIGS. 3 and 4, and each of the frames comprises encoded information. In step 830, a user can use the user interface 150 to output the encoded command signal. The micro controller 130 is used to determine whether the encoded command signal is received. When the micro controller 130 receives the encoded command signal, the motor 120 can be controlled to drive the camera lens to turn to the frame corresponding to the encoded command signal by the micro controller 130 such that the video camera 110 zooms in the frame. However, the moved distance of the video camera 110 shall be obtained first to determine the rotation speed of the motor 120. Therefore, the step 840 can be performed to calculate the moved distance of the camera lens by the micro controller 130, and said calculating mode is recited in FIG. 7. If the camera lens moves from the frame labeled by 9 to the frame labeled by 2, the distance calculated by the micro controller 130 is 3 frames.

Hence, the method 800 for controlling a video camera positioning system of the embodiment of the present disclosure can be performed to divide the panoramic frame into a plurality of frames such that a user can select the frame he want to zoom in through the user interface 150, and therefore, there is no need an additional instrument.

The encoded command signal as mentioned in step 830 is generated by at least one number. When the micro controller 130 receives the encoded command signal, the motor 120 is controlled to drive the camera lens to turn to at least one frame corresponding to the encoded command signal such that the video camera 110 can zoom in at least one frame. The detailed description of the encoded command signal is recited in the description of FIGS. 5a to 5d, so the detailed description of the encoded command signal is omitted herein.

Referring to step 840, the micro controller 130 controls the motor 120 to rotate with corresponding speed based on the distance and drive the camera lens to turn to at least one frame corresponding to the encoded command signal. The way to obtain the speed is described as follows.

The micro controller 130 is operable to divide the panoramic frame into n×n frames, and n is a positive integer and greater than 2. The micro controller 130 controls the motor 120 to drive the camera lens to turn to the frame for a distance. When the distance is greater than 2n−3 frames, the micro controller 130 is operable to look up the distance-speed table for obtaining the first speed to control the motor 120 to rotate with the first speed. When the distance is one frame, the micro controller 130 is operable to look up the distance-speed table for obtaining the second speed to control the motor 120 to rotate with the second speed. When the distance is less than 2n−3 frames and greater than one frame, the micro controller 130 is operable to look up the distance-speed table for obtaining the third speed to control the motor 120 to rotate with the third speed. However, the present disclosure is not intended to be limited to this regard, the rotation speed of the motor 120 can be obtained by looking up the distance-speed table or calculated by the micro controller 130 directly according to the distance.

Hence, the way to adjust the motor rotation speed depending on the distance can let the motor 120 rotate with a proper speed when the distance is farther such that the positioning time can be reduced, that is to say, the positioning time is just the same for a user each time even if the distance is farther because of the positioning time is adjusted as the above-mentioned way. Moreover, the micro controller 130 can the outputting current of the control motor 120 based on the distance such that the motor 120 can rotate in different speeds properly in order to reduce power consumption.

In step 850, the frame is zoomed in or zoomed out by the video camera 110, and the related operation to zoom in the frame is recited in the description of FIGS. 5a to 5d, so the detailed description of above-mentioned operation is omitted herein.

Furthermore, the frame can be divided into a plurality of subframes by the micro controller 130, and each of the subframes comprises encoded information. A user can use the user interface 150 to output the encoded command signal. When the micro controller 130 receives the encoded command signal, the motor 120 is controlled to drive the camera lens to turn to the subframe corresponding to the encoded command signal such that the video camera 110 can further zoom in the subframe.

Hence, a user can use the method 800 for controlling a video camera positioning system of the embodiment of the present disclosure to zoom in single frame or subframe based on the actual requirement or zoom in a region frame consisted of a plurality of frames or subframes. The zoomed-in frame can be further divided to perform zoom-in processes based on the user's requirement.

In step 850, the operation to reduce the frame by the video camera 110 is recited as follows. A user can enter a zoom out command manually through the user interface 150, and the user interface 150 will generate a zoom out command signal. If the video camera 110 zooms in any frame of the panoramic frame at the time the micro controller 130 receives a zoom out command signal, the video camera 110 is controlled by the micro controller 130 to reduce the frame captured by the video camera 110 and return to the panoramic frame. Furthermore, if the video camera 110 zooms in any subframe of the frame at the time the micro controller 130 receives the zoom-out command signal, the video camera 110 is controlled by the micro controller 130 to reduce the subframe captured by the video camera 110 and return to the frame.

Those having skill in the art will appreciate that the method 800 for controlling a video camera positioning system can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the method 800 for controlling a video camera positioning system named after the function thereof is merely used to describe the technology in the embodiment of the present disclosure in detail but not limited to. Therefore, combining the steps of said method into one step, dividing the steps into several steps, or rearranging the order of the steps is within the scope of the embodiment in the present disclosure.

In view of the foregoing embodiments of the present disclosure; many advantages of the present disclosure are now apparent. As the embodiments of the present disclosure, a video camera positioning system and a method for controlling thereof can record the panoramic frame in advance, so as to avoid the problem of unable to select the edge portion for zoom in, regardless the object of interest being too large or the visual angle of the video camera 110 being too small. Also, the present disclosure can zoom in single frame or subframe based on the actual requirement or zoom in a region frame consisted of a plurality of frames or subframes. The zoomed-in frame can be further divided to perform zoom-in processes based on the user's requirement.

Moreover, the embodiment of the present disclosure provides a video camera positioning system and a method for controlling thereof, so as to adjust the motor rotation speed depending on the distance to let the motor 120 rotate with a desired speed when the distance is farther such that the positioning time can be reduced, that is to say, the positioning time is just the same for a user each time even if the distance is farther because of the positioning time is adjusted as the above-mentioned way. Moreover, the micro controller 130 can control the outputting current of the motor 120 based on the distance such that the motor 120 can rotate in different speeds properly in order to reduce power consumption.

It will be understood that the above description of embodiments is given by way of example only and that various modifications may be made by those with ordinary skill in the art. The above specification, examples and data provide a complete description of the structure and use of exemplary embodiments of the disclosure. Although various embodiments of the disclosure have been described above with a certain degree of particularity, or with reference to one or more individual embodiments, those with ordinary skill in the art could make numerous alterations to the disclosed embodiments without departing from the spirit or scope of this disclosure, and the scope thereof is determined by the claims that follow.

What is claimed is:

1. A method for controlling a video camera positioning system, the video camera positioning system comprising a video camera, a motor, and a micro controller, the method comprising:
controlling the motor for the video camera to capture a panoramic frame;
dividing the panoramic frame into a plurality of frames, wherein each of the frames comprises encoded information;
controlling the motor to turn a lens of the video camera to the frame corresponding to an encoded command signal when the micro controller receiving the encoded command signal; and
zooming in the frame by the video camera.

2. The method according to claim 1, wherein the panoramic frame is divided into n×n frames by the micro controller, and n is a positive integer greater than 2; and the micro controller controls the motor to turn the lens of the video camera to the frame for a distance, wherein the motor is controlled by the micro controller to rotate with a first speed when the distance is greater than 2n−3 frames, the motor is controlled by the micro controller to rotate with a second speed when the distance is one frame, and the motor is controlled by the micro controller to rotate with a third speed when the distance is less than 2n−3 frames and greater than one frame.

3. The method according to claim 2, wherein the micro controller is operable to look up a distance-speed table for respectively obtaining the first speed, the second speed, and the third speed when the distance is greater than 2n−3 frames, equal to one frame, and less than 2n−3 frames and greater than one frame.

4. The method according to claim 1, wherein the frame is divided into a plurality of subframes by the micro controller, and each of the subframes comprises the encoded information; and the micro controller is operable to control the motor to turn the lens of the video camera to the subframe corresponding to the encoded command signal when the micro controller receives the encoded command signal, such that the video camera further zooms in the subframe.

5. The method according to claim 4, wherein, if the micro controller receives a zoom-out command signal at the time the video camera zooming in any frame of the panoramic frame, the video camera is controlled by the micro controller to zoom out the frame captured by the video camera and return to the panoramic frame, and, if at the time the video camera zooming in any subframe of the frame, the video camera is controlled by the micro controller to zoom out the subframe captured by the video camera and return to the frame.

6. A video camera positioning system, comprising:
a video camera;
a motor electrically connected to the video camera; and
a micro controller electrically connected to the motor, and operable to control the motor for the video camera to capture a panoramic frame,
wherein the micro controller is operable to divide the panoramic frame into a plurality of frames, and each of the frames comprises encoded information; and the micro controller is operable to control the motor to turn a lens of the video camera to the frame corresponding to an encoded command signal when the micro controller receives the encoded command signal, such that the video camera zooms in the frame.

7. The video camera positioning system according to claim 6, wherein the micro controller is operable to divide the panoramic frame into n×n frames, and n is a positive integer greater than 2; and the micro controller is operable to control the motor to turn the lens of the video camera to the frame for a distance, wherein the micro controller is operable to control the motor to rotate with a first speed when the distance is greater than 2n−3 frames, the micro controller is operable to control the motor to rotate with a second speed when the distance is one frame, and the micro controller is operable to control the motor to rotate with a third speed when the distance is less than 2n−3 frames and greater than one frame.

8. The video camera positioning system according to claim 7, further comprising:
a memory operable to store a distance-speed table, wherein the micro controller is operable to look up the distance-speed table for respectively obtaining the first speed, the second speed, and the third speed when the distance is greater than 2n−3 frames, equal to one frame, and less than 2n−3 frames and greater than one frame.

9. The video camera positioning system according to claim 6, wherein the micro controller is operable to divide the frame into a plurality of subframes, and each of the subframes comprises the encoded information; and the micro controller is operable to control the motor to turn the lens of the video camera to the subframe corresponding to the encoded command signal when the micro controller receives the encoded command signal, such that the video camera further zooms in the subframe.

10. The video camera positioning system according to claim 9, wherein, if the micro controller receives a zoom-out command signal at the time the video camera zooming in any frame of the panoramic frame, the micro controller is operable to control the video camera to zoom out the frame captured by the video camera and return to the panoramic frame, and, if at the time the video camera zooming in any subframe of the frame, the micro controller is operable to control the video camera to zoom out the subframe captured by the video camera and return to the frame.
